(19) United States
(12) Patent Application Publication
(10) Pub. No.: US 2023/0330578 A1
(43) Pub. Date: Oct. 19, 2023

(54) Filtration Apparatus and Method

(71) Applicant: Noetix Pharma LLC, Bethesda, MD (US)

(72) Inventor: Arnold L. Newman, Bethesda, MD (US)

(21) Appl. No.: 18/007,878

(22) PCT Filed: Jun. 15, 2021
(86) PCT No.: PCT/US2021/037358

§ 371 Date: Dec. 2, 2022

Related U.S. Application Data
(60) Provisional application No. 63/102,542, filed on Jun. 19, 2020.

(51) Int. Cl. B01D 45/16; B01D 46/40; B01D 50/20

(52) U.S. Cl. CPC B01D 45/16; B01D 46/403; B01D 50/20

(57) ABSTRACT

A filtration apparatus for improving quality of breathable air, containing a plurality of vortex forming elements, each containing a) a fixed swirler for imparting a centrifugal force on a moving air stream; and b) a filter matrix for capturing particles contained within said moving air stream, wherein the vortex forming elements are disposed within the filter matrix.

### BACKGROUND OF THE INVENTION

There is a need for a filtration apparatus and method that efficiently removes impurities such as solid particles, liquid droplets, and aerosols from gases. This need is currently especially urgent because of the corona virus pandemic and global climate change, both of which present an existential threat to humanity.

The threat of viruses has been acutely manifested by the SARS, MERS, and Ebola viruses, and now, particularly, by the corona virus pandemic. There has been a well-documented, critical shortage of masks for both healthcare workers and the general population. Beyond this shortage, it is clear that current mask technology is inadequate and needs to become more effective in filtering pathogens to prevent viral spread. Without a doubt, both emerging and recurrent viral contagions will continue to be problematic for humanity in the future.

In the long term, global climate change may be an even greater threat to humanity than viruses and other pathogens. Technology must be transformed greatly to reduce the release of pollutants, greenhouse gases, and minimize energy use. Filters are ubiquitous across technology and are vital in removing pollutants and undesirable particulates in many processes. However, because they inherently resist fluent flow, they also dissipate energy and produce heat. Improving filtration efficiency will more effectively limit pollution and diminish energy consumption.

An efficient filter would remove impurities completely or to the extent that any residual impure content of a gas is of insufficient quantity to cause harm downstream of the filter. An efficient filter also provides an increased average filtration path length for impurities while minimizing resistance to gas flow.

A need exists for a means of more effective filtration by efficiently removing impurities while minimizing gas flow resistance.

### SUMMARY OF THE INVENTION

The present invention provides an efficient filtering apparatus for removing particulate matter in air while reducing air flow resistance through the filtering material.

The present invention further provides a means of inhibiting the spread of infectious airborne pathogenic viruses and bacteria.

The present invention further reduces breathing difficulties of people suffering from conditions, such as COPD, asthma, or emphysema, which are all exacerbated by particulate airborne materials, such as pollen, dust, coal dust, viruses and bacteria.

Accordingly, these advantages and others are provided by a filtering apparatus for improving quality of breathable air, containing a plurality of vortex forming elements each vortex element containing: 1) a fixed swirler for imparting a centrifugal force on a moving air stream, and 2) a filter matrix for capturing particles contained within said air stream, wherein said vortex forming elements are disposed within said filter matrix.

### BRIEF DESCRIPTION OF THE DRAWINGS

FIG. 1 is a three-dimensional drawing of a single vortex forming element shown as a helical blade within a vortex port and associated filter material and which illustrates a simplified operation of the present invention.

FIG. 2 is a three-dimensional drawing of a portion of a vortex array comprising a plurality of vortex ports embedded within associated filter material.

FIG. 3A is a three-dimensional drawing of a portion of a vortex array comprising a plurality of vortex forming blades disposed directly within, and in intimate contact with, a filter matrix. FIG. 3B is a three-dimensional drawing of a portion of a vortex array comprising a plurality of vortex forming blades disposed directly and intimately within a filter matrix the top face of which is covered by a gas impermeable material with ports aligned with the vortex forming blades.

FIGS. 4A-H illustrate a variety of swirler configurations,

FIG. 5 illustrates the operation of a swirler with a hollow axis.

FIG. 6A-H are cross-section illustrations showing a variety of configurations for disposing swirlers within the matrix of a filter material.

FIGS. 7A and B are cross-section illustrations showing additional varieties of configurations for disposing swirlers within the matrix of a filter material.

FIG. 8 is a cross-section showing two opposing helical swirlers, each having one turn.

FIG. 9A illustrates a plurality of swirler blades incorporated into the face of a gas-impermeable layer. FIG. 9B is a close-up illustration of a single blade of the configuration shown in FIG. 9A.

FIG. 10A shows a face mask with an insertable filter module. FIG. 10B is an exploded view of the insertable filter module with an expanded depiction of a helical swirler.

FIG. 11A shows a face mask with an array of helical blade eyelet swirlers. FIG. 11B is a profile drawing of a single helical blade eyelet swirler.

FIG. 12 illustrates a filter apparatus incorporating the present invention for use in ventilation systems or for HEPA filtration.

### DETAILED DESCRIPTION OF THE PREFERRED EMBODIMENTS

### Term Definitions

As used hereinbelow, the following terms have the noted definitions:

About: means plus or minus 10% of a given value. Thus, for example, the meaning of the phrase “about 10” means from 9 to 11.

Swirler: means both helical blades or impeller blades, which are necessarily in a fixed or static position, and never move, but impart a swirling motion to a moving air stream.

Helical blade: means a blade with a helical surface or a blade having a surface helicity. The helical blade can range in length from a fraction of a turn to multiple turns. It can be continuous over this range or include gaps or discontinuities along this range. It can have a constant pitch, a variable pitch, and a draft angle of zero or greater (i.e., constant or variable, such as a tapered radius).

Impeller blade: means a fixed device shaped to alter the flow and/or pressure of liquids, gases, and vapors and to impart a centrifugal force thereon.

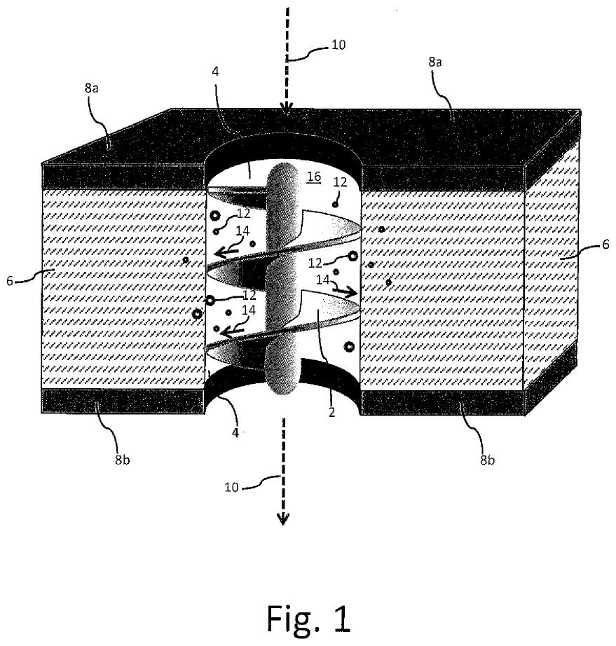

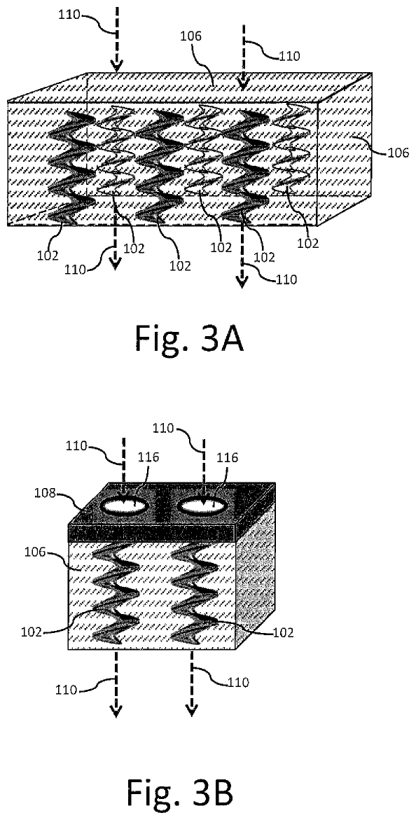

Vortex forming element: means the element or component of the filtering apparatus that generates centrifugal force, and includes helical blades or open impellers. See FIGS. 1 and 3B, for example.

Vortex port: means an opening or an intake egress for the entering air stream to be subjected to the vortex forming elements.

Vortex port array: means an array of vortex ports or intakes for the vortex forming elements, each vortex port containing a vortex forming element in a bore or conduit, See FIG. 1, for example.

Particle: means any solid particle or particulate such as pollen or dust, including coal dust; but it also means liquid droplets and aerosol droplets which may carry airborne viral and/or bacterial contagions. The particles are necessarily of higher density than the air of the air stream in which they may occur. The definition of particle also includes droplets which may be too large to be aerosols, but which may be contained in the air stream, nonetheless.

Filter matrix or material: means any material which is absorbent and/or adsorbent, and/or porous and/or anti-bacterial and/or anti-viral or that may have all of these properties within one or more layers.

Improving the quality of breathable air: means reducing a content of particulate matter in breathable air after passing through the present filtering apparatus. The particulate matter so reduced may include pollen, dust (including coal dust), airborne bacteria and viruses (including bacteria and viruses in airborne aerosols).

The present invention is an apparatus and method that provides for efficient use of a greater portion of a filter material than is typically used while also lowering resistance to gas flow. Particles in a flowing stream of gas or gas mixture, such as air, are separated and removed from the stream by means of centrifugal force and thereby diverted into a filter material in a direction that is generally radial to the axis of gaseous flow. Gas is caused to flow through a vortex port that includes at least one static (i.e., immovable) swirler, which can be a static helical blade or fixed impeller-like device that imparts, by virtue of its structure, a swirling, cyclonic eddy, or vortex movement to the flowing gas stream. Particles in the gas can include solid and/or liquid materials. For example, solids can comprise dust particles and liquids can comprise droplets of a range of sizes including aerosols. Given that the particles to be filtered have a higher density than that of the fluent gas medium, these particles are urged radially into the filter material to a greater extent than the gas. This radial and, thus, transverse, direction into the filter material, can increase the mean path length of potential particle movement through the filter resulting in a concomitant increase in the likelihood that a particle will be captured by the filter. The present invention is made up of a plurality of vortex ports disposed within a filter material. Should a particle move from a first vortex port through the filter material into a second vortex port, it will be taken up by the second swirling flow or vortex and thus be urged again in a radial or transverse direction into the filter material. Thus, in the present invention, the plurality of swirlers produce a synergistic structure wherein neighboring swirlers cooperate functionally to urge radial or transverse movement of particles within the filter material. This increases the likelihood of a physical and/or chemical interaction between particles and the filter material. Thus, in one embodiment of the present invention there are no barriers to radial (i.e., transverse from swirlers) movement within the filter material other than the capture ability of the filter itself. In one version of this embodiment, at least one layer of filter matrix is continuous across its surface area with no discontinuities between swirlers disposed therein. In another version of this embodiment, in at least one layer of the filter matrix, there are discontinuities between the swirlers disposed therein. As one non-limiting example, discontinuities may be air spaces.

Although the distance between swirlers can be configured for a wide range of values, the preferred minimal distance between the centers of the central axes of adjacent swirlers is at least three radii (using the largest radius of the swirlers, whether they be of different sizes and/or of variable radial sizes along the swirler's length). The preferred maximum distance between the centers of the central axes of adjacent swirlers is no more than eight radii of the largest swirler's radius. However, smaller and larger distances between swirlers are also contemplated and these depend on the application and the content of the filter matrix, e.g., its resistance to air flow.

Thus, on average, the average particle path is not orthogonal to the filter face but more generally transverse into and through the filter thereby causing a greater chance of capture by and within the filter. While the present invention generally contemplates vortex ports that are orthogonal to a filter apparatuses' outer surface, it is also contemplated that vortex ports can be disposed at different angles to the outer surface of the filter. It is also contemplated that the present invention can also include vortex ports that are non-linear, for example, vortex ports that are curved. The particles to be removed from the air stream have a higher density than the air of the air stream.

In the present invention, vortices or eddies are formed by the interaction of fluent gas with swirlers, which are formed from at least one static or fixed helical blade, a static or fixed impeller, a helical tube or space formed within the filter material itself, or a similar fluid-swirling structure that is disposed within the filter material. The axes of the swirlers are generally parallel to the direction of gaseous flow. The axes of the swirlers are typically orthogonal to the outer face of the filter apparatus, but this is not a necessary requirement of the present invention. In the case where the axes of the swirlers are not orthogonal to the outer face of the filter apparatus, the swirlers will entrain at least a portion of the gas flow to be parallel to the swirler axes. The swirlers can range in length from a fraction of a turn to a plurality of turns. They can be of constant pitch or variable pitch, and they can have a constant radius or a variable radius. Swirlers can have a central axis from which helical or impeller-like blades extend radially, or the blades can be axis-free with dimensions and a closed or partially closed structure that inhibits all or most axial movement of particles. Swirlers can have a completely closed axis or an axis that is completely or partially open or hollow to allow the least dense material, i.e., gas, to move through the central axis less impeded by an involute path while denser impurities are urged radially through an involute path into filter material. Swirlers can also have no axis but, instead, an open space with a predetermined radius (either fixed or variable along its length) in place of an axis.

The combination of a swirler and its associated vortex effectively defines an involute path. In some embodiments, the swirler is virtual in that a spiral-shaped tunnel is formed within the filter material, which, because of its shape imparts a centrifugal force upon the airflow therein. In this case, the walls of the tunnel are effectively the swirler. Thus, in some embodiments, swirlers are disposed in involute conduits (i.e., spiral-shaped tunnels) formed within the filter material itself. In other embodiments swirlers are disposed directly within the filter material such that there is maximum, contiguous contact between the swirler and the filter material, that is, without a conduit parallel to the swirler's axis, formed to contain the swirler. In some embodiments, helical swirlers can have gaps or discontinuities in their blades. It is even contemplated that swirlers per se may comprise twisted strands of fibers directly integrated into, or integral with, a woven or non-woven filter matrix.

The outer faces or surfaces of a filter apparatus of the present invention need not be planar but, rather, can be shaped aerodynamically to optimize fluid flow and efficiently urge or funnel gas flow into vortex ports. Furthermore, outer surfaces of the filter apparatus of the present invention can be shaped to maximize filter surface area, for example, like an accordion shape.

FIG. 1 is a three-dimensional drawing that illustrates the structure and operation of one vortex port of the present invention. Helical blade 2 is non-moving, i.e., it is static or fixed, and is disposed axially within bore 4. Helical blade 2 and bore 4 together make up vortex port 16. Porous filter 6 is sandwiched between fluid impermeable layers 8 such that gas flow into and out of porous filter 6 can occur only through bore 4. In the embodiment shown in FIG. 1, bore 4 is a conduit through filter 6 and both fluid impermeable layers 8, with a first impermeable layer 8a and a second impermeable layer 8b sandwiching filter 6. Gas flow direction arrows 10 depict the direction of gas flow into and out of bore 4. However, as configured in FIG. 1, gas flow can be bidirectional, for example, to filter respiratory (i.e., inspired and expired) air of a mask. As gas flows through the bore, it is urged into a swirling motion by helical blade 2. This swirling motion imparts on particles contained within the gas flow a centrifugal force, the direction of which is generally radial and shown by particle direction arrows 14. For the purposes of this invention, the term “particle” comprehends both solid and liquid forms of matter, such as dust, liquid droplets, and aerosols. Under influence of centrifugal forces caused by the swirling motion of the gas flow, particles 12 are urged against the wall of bore 4 and into the matrix of filter 6, thereby being separated and removed from the gas flow.

The swirling motion of the gas can extend beyond the end of the helical blade 2 and filter 6 can be dimensioned to extend beyond helical blade 2, as well. Because the centrifugal force urges particles (e.g., impurities) into a radial and, thus, horizontal or transverse motion, a greater path length of movement through the filter matrix is provided. This is an improvement over conventional passive filter technologies wherein particles within an airstream generally move orthogonally to the filter's faces and are thus dispersed through the thinnest dimension of the filter.

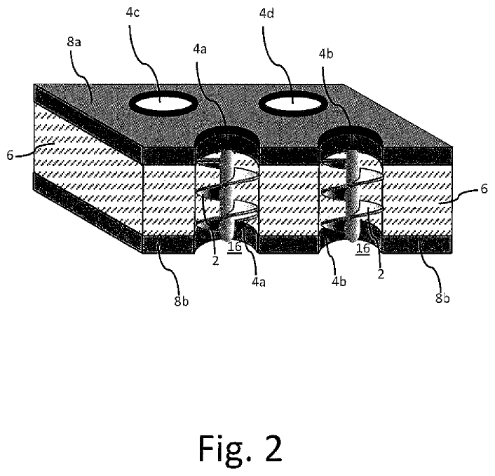

FIG. 2 is a three-dimensional drawing of a two-by-two (2×2) array of vortex ports 16 of the same configuration shown in FIG. 1. Any number of vortex ports 16 are contemplated by the present invention including n×n, n×m (i.e., when vortex ports 16 are arranged linearly, or as a square or rectangle) or any arrangement of vortex ports wherein m is equal to or greater than 1 and n is equal to or greater than 2. Vortex ports 16 of the present invention can be uniformly spaced or non-uniformly spaced. The overall pattern of vortex port 16 arrangement need not be linear or a square, rectangular, or of a regular shape but can be of a variety of shapes (including random or clustered placements) chosen for a particular application. The dimensions of individual vortex ports can be uniform throughout a filter or can vary according to their particular location on the filter. Furthermore, the present invention does not require that the filter structure be generally planar. For example, the filter can be of an “accordion” or other shape configured to increase surface area and optimize filter apparatus performance.

FIG. 2 shows 2×2 array of helical ports and a filter configuration of the present invention. As shown in the figure, vortex ports 16 and their associated filter components can comprise a complete filter configuration per se or they can comprise a portion of a larger filter. In this figure, helical blades 2 are shown disposed within a cutaway of two vortex ports 16, which are made up of first bore 4a and second bore 4b through first impermeable layers 8a and 8b, which sandwich porous filter 6. Details within third bore 4c and fourth bore 4d are not shown but they are of the same internal configuration as those of bores 4a and 4b.

FIGS. 3A and 3B show other embodiments of the present invention. In FIG. 3A, helical blades 102 are disposed directly within porous filter matrix 106. The direction of gas flow through the filter is generally parallel to the axis of helical blades 102 as shown by arrows 110. In this embodiment, helical blades 102 are embedded intimately within the porous filter matrix 106 such that the surface areas of helical blades 102 approach maximum contact with porous filter matrix 106, and a vortex port and bore are absent. Furthermore, filter matrix is not sandwiched between fluid impermeable layers. Helical blades 102 function to impart a centrifugal force on gas flowing through the filter and the impurities such as particles, droplets, and aerosols contained within the gas. Thus, impurities, which have a greater density than the flowing gas, are more likely to be deflected radially and transversely away from the general direction of gas flow. Additionally, helical blades 102 tend to increase the average path length of particles through a filter thereby increasing the likelihood of capture.

FIG. 3B shows a single portion of a filter, which is a variation of the embodiment shown in FIG. 3A. Helical blades 102 are disposed directly within filter matrix 106 similarly to those shown in FIG. 3A. However, for each helical blade (only two are shown) of this embodiment there is an associated port 116 within fluid impermeable layer 108, which serves to direct gas, flowing generally in the direction of gas flow direction arrows 110, particularly into the volume of filter matrix 106 occupied by each helical blade 102. In a variation of the embodiment of FIG. 3B (not shown), a second fluid impermeable layer 108 with associated vortex ports 116 are disposed opposite the first vortex ports 116 and first fluid impermeable layer 108 to form a sandwich of filter matrix 106 occupied by helical blades 102. Vortex ports 116 of the second fluid impermeable layer 108 can be coaxial or non-coaxial with (i.e., offset from) the vortex ports 116 of the first fluid impermeable layer 108.

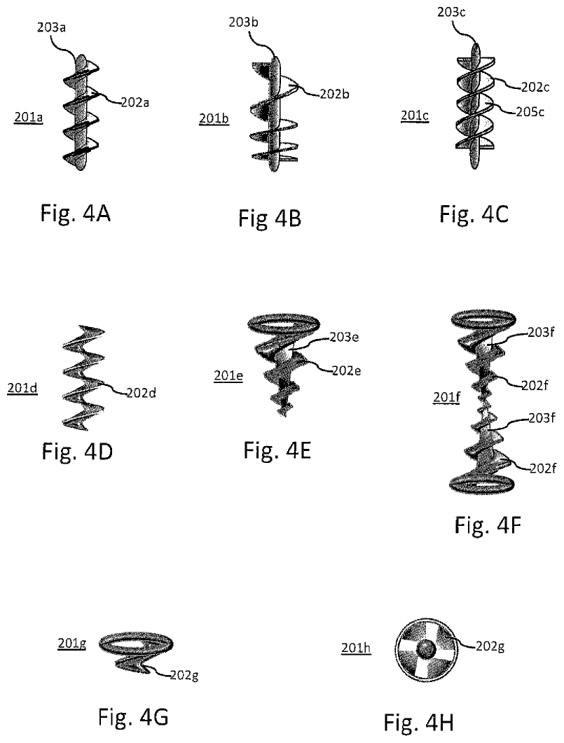

FIGS. 4A-H illustrate various swirler structures useful in the present invention. These are presented by way of example and are in no way meant to be limiting. FIG. 4A shows a swirler 201a with a central axis 203a and a helical blade 202a with a constant pitch and radius disposed around the central axis 203a. A vortex port formed by swirler 201a in combination with a bore would produce a regular and constant dimensioned helical passage between the walls of the bore, axis 203a and helical blade 202a. A variation of this swirler configuration (not shown) is a swirler with a regular helical blade with a constant pitch and radius disposed around the central axis that is tapered along its length,

FIG. 4B shows a swirler 201b with central axis 203b and helical blade 202b with a varying pitch along central axis 203b but with a constant radius. A vortex port formed by swirler 201b in combination with a bore will have a helical passage of changing dimensions formed between and defined by the walls of the bore, axis 203b, and helical blade 202b.

FIG. 4C shows swirler 201c with central axis 203c and first helical blade 202c and second helical blade 205c, wherein first helical blade 202c and second helical blade 205c are intertwined and, as shown, are 180 degrees out of phase with each other. Thus, the blades of this swirler define two helical passages bounded by the walls of axis 203c, a bore, and first helical blade 202c and second helical blade 205c, There is no limit on the number of blades of a swirler, their pitch or radius dimensions contemplated by the present invention. Thus, FIG. 4C illustrates the use of a plurality of blades without being limiting.

FIG. 4D shows a swirler 201d that lacks a central axis. The dimensions of helical blade 202d are such that there is no space or an extremely small space extending axially along its length. A vortex port formed by swirler 201d in combination with a bore will have a helical passage of constant dimensions.

FIG. 4E shows a swirler 201e with varying radius, central axis 203e, with helical blade 202e that has constant pitch but a varying radius, as shown. Swirler 201e can be used in combination with a bore whose shape varies radially along its length to form a cone or a frustoconical space that accommodates swirler 201e. Alternatively, swirler 201e can be used in combination with a bore that is cylindrical or another shape that does not follow or fit the dimensions of swirler 201e. Helical blade 202e could alternatively have a variable pitch.

FIG. 4F shows swirler 201f whose shape is tapered toward its middle, similar in shape to an hourglass. Thus, central axis 203f and helical blade 202f have a larger radius toward each end of swirler 201f and a smaller radius toward the center of swirler 201f. Helical blade 202f is shown with a constant pitch but could, alternatively, have a variable pitch. Swirler 201f can be used in combination with a bore whose shape varies radially along its length to form an hourglass-shaped space that accommodates swirler 201f. Alternatively, swirler 201f can be used in combination with a bore that is cylindrical or another shape that does not follow or fit the dimensions of swirler 201f.

FIG. 4G shows swirler 201g without a central axis but with helical blade 202g whose length is a single turn. The present invention contemplates helical or other shaped blades whose length can vary between a fraction of a turn to a plurality of turns.

FIG. 4H is a view of swirler 201h with four blades 202g, which, although shaped like a propeller or impeller, like all the blades of the present invention, do not move. Swirlers of the present invention do not have limitations on blade shape other than that they must contribute to and/or cause a swirling motion of fluids to urge particles into and/or through a filter material.

Alternative embodiments not shown in FIGS. 4A-4H include those in which the central axis is removed and replaced by a space with the same shape as the removed axis. A filter can have helical swirler blades all of one configuration or a mix of different configurations such as those shown in FIGS. 4A-H, but not be limited thereto. Furthermore, the chirality (i.e., handedness) of a plurality of helical swirler blades can be the same or mixed. That is, in a particular filter, the plurality of helical swirler blades can be all right-handed, ail left-handed or include both right-handed and left-handed helical swirler blades.

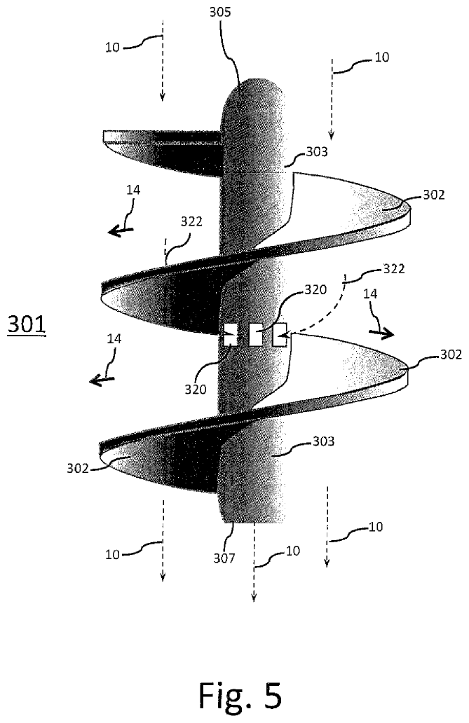

FIG. 5 illustrates the function of an alternative embodiment showing swirler 301 with helical blade 302 and hollow axis 303, with a closed end 305 and an open end 307. Axis 303 can be hollow or partially hollow. Gas flow direction arrows 310 indicate the direction of gas flow, which is generally, but not necessarily, parallel to axis 303 of swirler 301. Helical blade 302 of swirler 301 imparts a swirling motion and, thus, a centrifugal force upon the contents of the flowing gas. Denser components of the flowing gas tend to move in the direction of particle direction arrows 314. Thus, they are urged outward, away from central axis 303. Less dense components of the flowing gas, particularly gas itself, tend to be less affected by the centrifugal force. Gas nearer to central axis 303 becomes purer. At least a portion of this gas is able to move into hollow axis 303 through axis ports 320 and out through open end 307. This will tend to decrease total resistance to gas flow. As an alternative to axis ports 320, hollow axis 303 can be made of a porous material that allows air to enter into hollow axis 303. A variation on this embodiment is the use of a helical blade such as helical blade 202d shown in FIG. 4D but with an axial opening or space extending along the length of helical blade 202d.

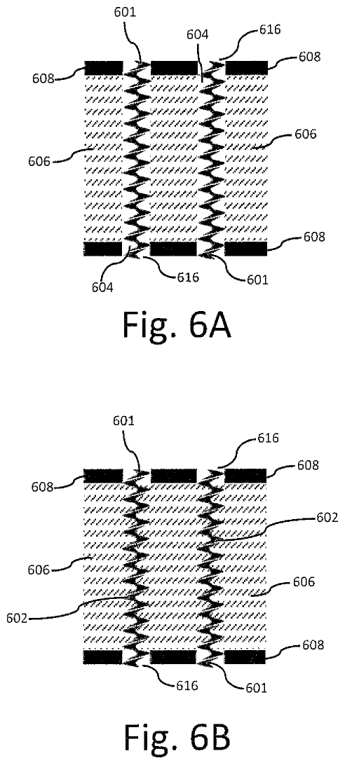

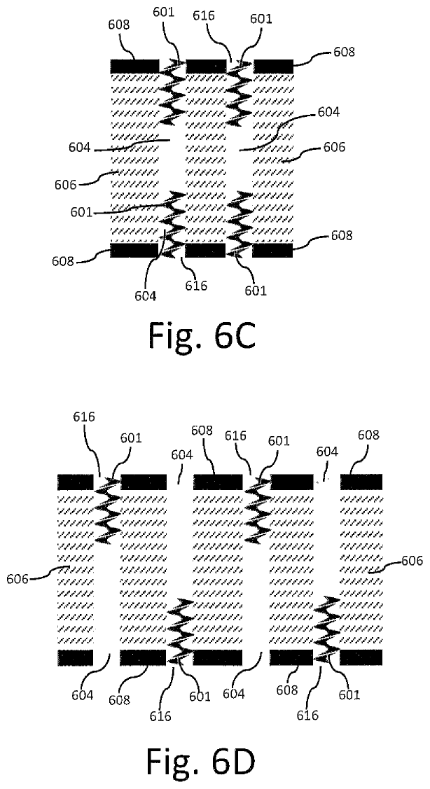

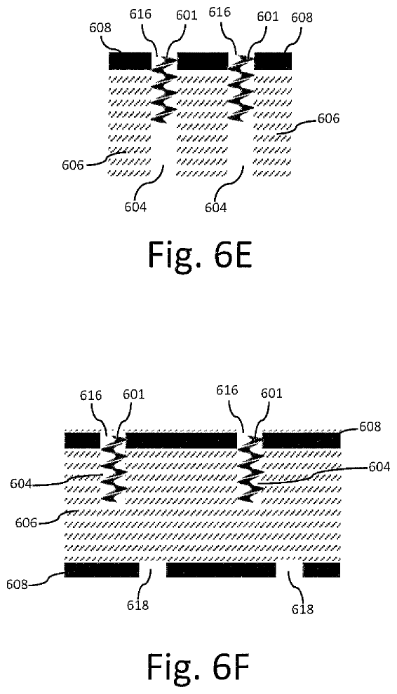

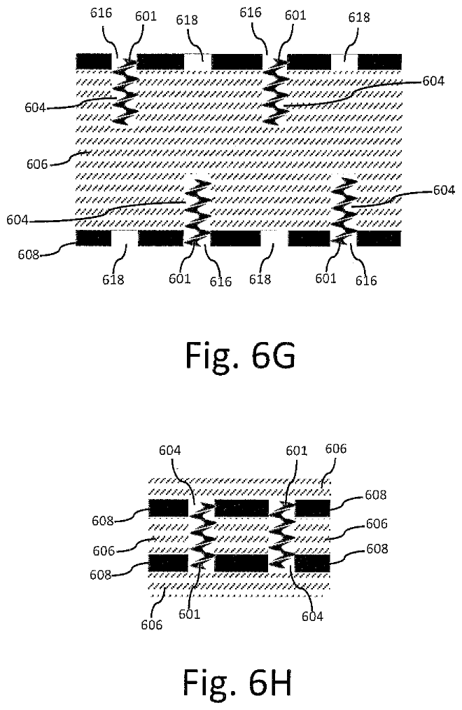

FIGS. 6A-H show a variety of configurations of the present invention. The purpose of each configuration shown is to illustrate the function of a filtration structure or to illustrate the function of a portion of a filtration structure. For example, any particular configuration may be a part of a more complex filtration structure, such as when the configuration shown is just one layer of a multilayered structure that may or may not include additional layers of filter matrix and/or additional layers containing swirlers. These figures are provided by way of illustration and are by no means meant to be limiting. Additional configurations not shown are comprehended by the present invention.

FIG. 6A shows swirlers 601 embedded in porous filter matrix 606, which is sandwiched between two fluid impermeable layers 608. Swirlers 601 extend through bore 604 completely through porous filter matrix 606 sandwiched between fluid impermeable layers 608. Vortex port 616 is made up swirler 601 and bore 604, which is a conduit or hole that passes through fluid impermeable layers 608 and porous filter matrix 606, which is sandwiched between fluid impermeable layers 608.

FIG. 6B is the same configuration as that of FIG. 6A except that there is no bore 604 through porous filter matrix 606. Instead, helical blades 602 and, thus, the swirler, are disposed directly within, and intimately contiguous with, filter matrix 606. In this configuration, the surface area of helical blades 602 is in direct, maximum contact with the material or materials of filter matrix 606, Every configuration shown in FIGS. 6A-H can also be structured this way, that is, without a bore 604 through porous filter matrix 606 but, for the purpose of brevity this structure is only shown in FIG. 6B. It should be noted that this general structure is comprehended by FIGS. 3A and 3B.

FIG. 6C shows two pairs of swirlers 601 that partially extend through bore 604 with a space in bore 604 between the opposing ends of each pair of swirlers 601. Each member of each pair of swirlers 601 is coaxial with the other pair member of swirlers 601. Bore 604 is a conduit or hole that passes through fluid impermeable layers 608 and porous filter matrix 606, which is sandwiched between fluid impermeable layers 608. In this example, vortex port 616 is made up of a pair of swirlers 601 and bore 604.

FIG. 6D shows four vortex ports 616 made up of swirlers 601 extending partially into bores 604 from fluid impermeable layers 608. Swirlers 601 are disposed non-coaxially, alternating their extension into porous filter matrix 606, one swirler 601 extending from a first fluid impermeable layer 608 and the next swirler 601 extending from an opposing second fluid impermeable layer 608.

FIG. 6E shows two swirlers 601 extending from fluid impermeable layer 608 partially into bores 604, which are conduits through fluid impermeable layer 608 into porous filter matrix 606. This configuration has only one fluid impermeable layer 608. Vortex ports 616 are made up of swirlers 601 and bore 604 through fluid impermeable layer 608 and porous filter matrix 606.

FIG. 6F shows two vortex ports 616 made up of swirlers 601 within bores 604 both extending from a first fluid impermeable layer 608 partially into filter matrix 606. Fluid flow ports 618 through a second fluid impermeable layer 608 are non-coaxial with access ports 616, that is, they are offset from the axes of swirlers 601 and bores 604.

FIG. 6G shows four vortex ports 616 made up of swirlers 601 within bores 604 each of swirlers 601 and associated bores 604 extending only partially into porous filter matrix 606. Swirlers 601 are disposed non-coaxially, alternating their extension into porous filter matrix 606, one swirler 601 extending from a first fluid impermeable layer 608 and the next swirler 601 extending from a second fluid impermeable layer 608. Associated and coaxial with each swirler 601 is fluid flow port 618 disposed within the opposing fluid impermeable layer 608.

FIG. 6H shows two swirlers within bores 604 both of which extend from a first fluid impermeable layer 608, through a portion of porous filter matrix 606 to a second fluid impermeable layer 608. Each fluid impermeable layer 608 is covered by a layer of porous filter matrix 606, which extends beyond the outer surface of each fluid impermeable layer 608.

The present invention comprehends single or multiple layers of the structures shown in FIGS. 6A-G. Multiple layers can be homogeneous in the use of structures in that each layer uses the same configuration or they can be heterogeneous in that different configurations are used in different layers. For example, a configuration can be a structure made up of multiple layers of the same material wherein each layer is a unitary (e.g., single piece) material or a granular substance or substances. Additionally, a configuration can be a structure made up of multiple layers wherein at least one layer is of a unitary material and at least one layer is of a granular substance or substances. It is also contemplated that different configurations can be used in the same layer of a filtration device. Furthermore, the structures shown in FIGS. 6A-H may be sub-components of a filter structure. That is, they may comprise one functioning element of a filter made up of multiple functioning elements.

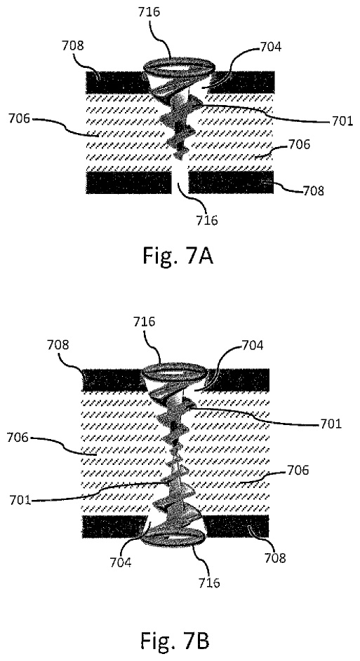

FIGS. 7A and 7B show radially tapered swirlers, each paired with similarly shaped bores. These swirlers correspond, respectively, to those shown in FIGS. 4E and 4F. FIG. 7A shows a swirler 701 whose helical blade and axis taper and extend longitudinally through a similarly shaped bore 704 from a first fluid impermeable layer 708 through porous filter matrix 706 to a second fluid impermeable layer 708 through which the bore provides an exit from vortex port 716. In an alternative embodiment, bore 704 has a cylindrical shape.

FIG. 7B shows an hourglass-shaped vortex port 716 comprising a swirler 701 with helical blades and axis that taper longitudinally from both ends toward the middle. That is, the radii of swirler 701 helical blades and axis are reduced moving from either end of swirler 701 to the middle of swirler 701. Swirler 701 is within bore 704, which has a similar hourglass shape. Alternatively, swirler 701 can have a bore 704 that is cylindrical (not shown). Vortex port 716 extends from fluid impermeable layers 708 through porous filter matrix 706.

FIG. 8 shows vortex port 816 consisting of a pair of opposing coaxial swirlers extending partially into bore 804, which extends from a first fluid impermeable layer 808 through porous filter matrix 806 to a second fluid impermeable layer 808. Helical blades 802 are of a single turn and are of the type shown in FIG. 4G.

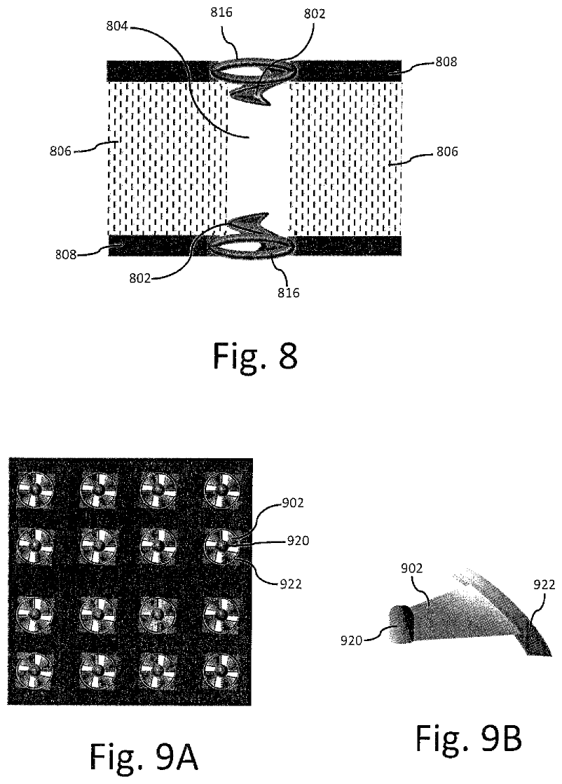

FIG. 9A shows an array of helical ports each of which consists of four fixed or static blades 902 extending radially from hub 920 to outer ring 922. Blades 902 flare out and are connected to outer ring 922, and are structurally similar to fan or impeller blades except that they are fixed. A single example of this structure is shown in FIG. 4H. FIG. 9B is a more detailed depiction of a single blade portion of the helical ports of FIG. 9A. Blade 902 is shown fixed and extending from hub 920, flaring out toward, and fixed to, outer ring 922.

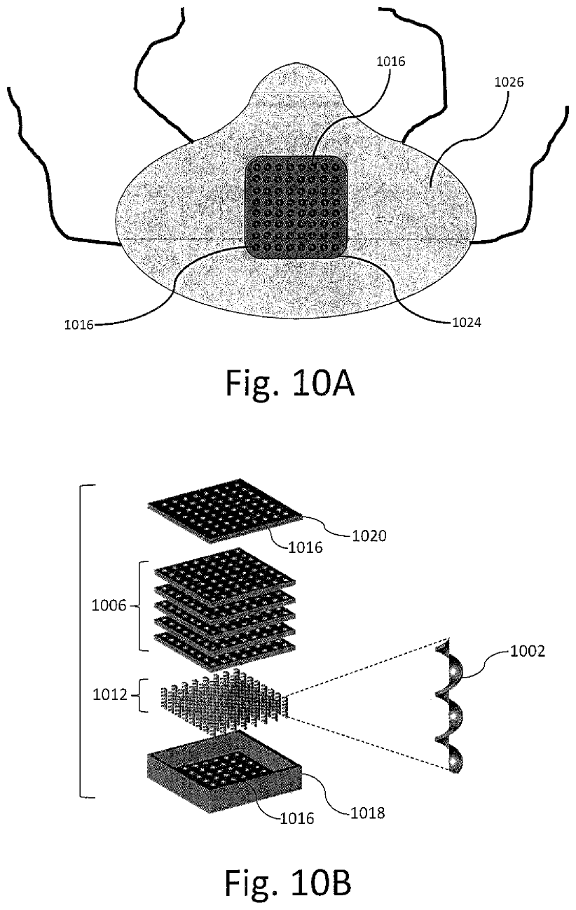

FIG. 10A is of a personal protective equipment (PPE) mask useful to protective against pathogens. Vortex ports 1016 are contained within insertable filter module 1024, which is incorporated into mask body 1026. Mask body 1026 can be permeable or impermeable to air.

FIG. 10B is an exploded view of insertable filter module 1024 including an expanded depiction of single helical blade 1002. Helical blade array 1012 is positioned for insertion into porous filter matrix layers 1006 wherein each helical blade of helical blade array 1012 is coaxial with a vortex port 1016, a plurality of which is disposed in case 1018 and cover plate 1020.

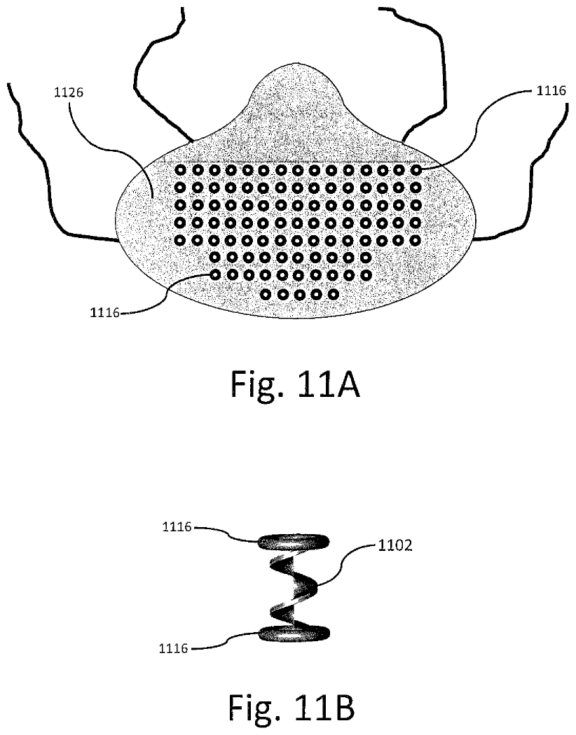

The PPE mask of FIG. 11A has vortex ports 1116 incorporated directly into mask body 1126. That is, vortex port 1116 is disposed as an array of ports across, or partially through, the filter matrix material of the mask. In this figure, each vortex port 1116 is viewed axially, that is, looking into the port. Mask body 1126 can be permeable or impermeable to air.

FIG. 11B is a profile drawing of a single helical blade eyelet swirler 1102 that comprises a helical blade connecting a vortex port 1116 at each end. Helical blade eyelet swirler 1102 can be inserted and set through the layer or layers of a filter's material. A helical blade eyelet swirler 1102 can have a snap-fit or crimp configuration, or other functional structure known in the art of eyelets and grommets.

The present invention can be applied to masks that can be washed, de-contaminated, and worn multiple times. Masks with insertable filter modules can be worn repeatedly with periodic filter replacement. Mask and filter materials can be ecologically friendly, i.e., recyclable and/or biodegradable with limited environmental impact.

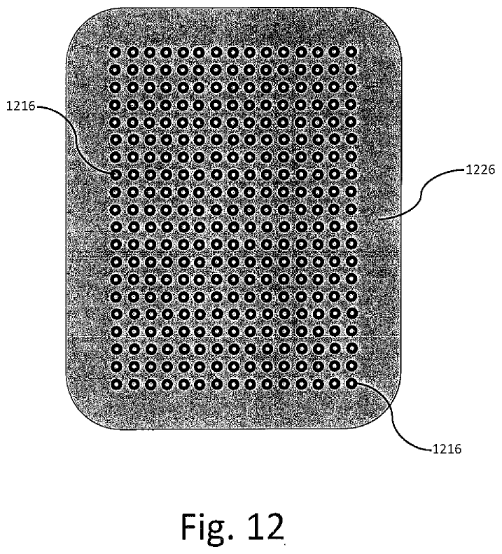

Vortex ports 1216 of the ventilation (e.g., HVAC) filter shown in FIG. 12 are disposed as a rectangular array across the face of, and into the filter matrix material, of filter body 1226. Alternative HVAC embodiments can include, but are not limited to, the swirler configurations of FIGS. 4A-H, FIGS. 6A-H and others disclosed hereinabove.

There is no requirement that vortex ports be of equal dimensions in a particular apparatus. For example, the vortex ports of the PPE mask of FIG. 11A may be sized differently at different locations on the mask. More peripheral vortex ports may have smaller radii as opposed to more central vortex ports, which are located closed to the mouth and nose, and thus are located closer to the most direct and higher velocity air flow. Generally, vortex ports can be dimensioned according to their location on a filter and the different gas flow velocities their particular location is likely to encounter in a given use environment.

As a PPE mask embodiment, the present invention optimizes filtration and minimizes airflow resistance because air passes through comparatively large ports while contaminants are centrifugally removed. This is in contrast to, and an improvement over, conventional masks, which capture particles by limiting permeability to airflow thereby causing a high resistance that makes breathing more uncomfortable for the user and can cause leakage at the mask periphery. Because airflow seeks the path of least resistance and the swirler array of the present invention is positioned close to the nose and mouth, peripheral mask leakage is minimized. Thus, the fit of the mask against the face can be less tight than conventional, high airflow resistant masks. This improves comfort and limits contact dermatitis and eyeglass fogging thereby increasing the likelihood that more people will use masks. This will encourage compliance and save lives.

### Filter Matrix Materials

Materials for the present invention can be chosen to enhance performance for particular applications. Materials can include, but not be limited to, metals, synthetic polymers (e.g., plastics), natural polymers (e.g., cellulose), biologically active components for binding specific chemical or molecular species (e.g., antibodies, receptors, etc.), and others known to those with skill in the art. For example, if it is desired to separate aqueous particles such as pathogen containing droplets or aerosols from an airstreams it may be advantageous to choose a hydrophobic polymer for fabricating swirlers and a hydrophilic material for a porous filter matrix. Water “beads up” on hydrophobic surfaces and flattens out and is “wicked up” on hydrophilic surfaces, Therefore, a swirler consisting of a hydrophobic polymer is more likely to “repel” an aqueous particle. In contrast, if choosing materials for a kitchen hood filter, which would be filtering an air stream containing oil and fat particles, it may be advantageous to choose a hydrophilic material for fabricating swirlers and a hydrophobic material for a porous filter matrix. These examples are provided to show the kind of approach one might use to make material choices for constructing the present invention in view of a particular application and are not meant to be limiting in any way.

For example, the filter matrix or material may be made of a porous nanofiber having a log reduction value greater than about 6. See U.S. Pat. No. 10,252,199, which is incorporated herein in the entirety by reference. As another example, the filter matrix or material may have an ultrafine fibrous coating having partially gelled submicron fibers interwoven with nanofibers and a biocide encapsulated in, surface-attached onto, blended with, physically trapped and/or chemically-linked to the submicron fibers and nanofibers. See U.S. Pat. No. 10,201,198, which is incorporated by reference herein in the entirety.

The filter matrix can comprise one or more fibrous materials and/or one or more granular materials. For example, the granular material can be activated carbon or it can contain activated carbon as a component thereof. Zeolites and silica gels are additional examples of filter materials that can be loose. For the purposes of the present invention, granular can also mean forms that are powdered, beaded, or of a variety of mesh sizes of a loose material or substance.

Further, the filtering matrix or material may contain a plurality of layers. For example, one layer may contain functional groups to trap viruses. It is known that sulfate and sulfonate functional groups mimic the binding action of sialic acid groups on viruses. See U.S. Pat. No. 8,678,002, which is incorporated herein by reference in the entirety. Other examples, of filter matrix materials with anti-bacterial and anti-viral properties as well as a deodorizing effect include those of U.S. patent application 2013/0291878, which is incorporated by reference herein in the entirety.

The filtering apparatus of the present invention is designed to capture particles as small as 0.3 microns, which necessarily includes airborne viral aerosols.

Of particular benefit, is the use of the present filtering device in screening out or trapping airborne viral particles, either in aerosols or droplets, from breathable air. This is especially urgent in view of the current SARS-CoV-2 pandemic, which may persist, and perhaps continue to circulate as a seasonal virus.

Notwithstanding the vaccines that have been developed for SARS-CoV-2, it is unlikely that SARS-CoV-2 will be completely eradicated.

As noted, the present filtering apparatus may have several distinct layers of filtering material. One layer may contain one or more types of multivalent metal ion, such as multivalent copper, multivalent silver and multivalent zinc. More specifically, the metallic ions are divalent. Another layer may contain sulfate or sulfonate groups, which are known to mimic sialic groups to which many viruses become bound. Examples of viruses that bind to terminal sialic acid groups at the end of oligosaccharide molecules on the surfaces of human cells include influenza viruses, respiratory syncytial virus and adeno-associated virus among others.

As examples of sulfate and sulfonate group used, particular mention may be made of sulfated monosaccharides, sulfated oligosaccharides, sulfonated monosaccharides and sulfonated oligosaccharides. Such groups are bound to a fabric layer with vinyl sulfone groups as linkers. U.S. Pat. No. 8,678,002, which is incorporated herein by reference in the entirety, discloses how both sulfated and sulfonated rayon fabric is prepared, how copper acetate and zinc acetate are applied as an aerosol to a rayon fabric layer, and finally how such one or more treated layers are assessed for anti-human pathogen properties.

Another example of an anti-microbial and anti-viral material is that of U.S. Pat. No. 7,169,404, which is incorporated herein by reference in the entirety.

In essence, polymeric slurries are prepared containing microscopic particles of water-insoluble ionic copper, which become both encapsulated within the formed polymeric fibers and also exposed on the fiber surfaces, Typically, CuO and Cu₂O are used in a particle size range of 1-10 microns, and in an amount of 0.25 to 10% by weight based on the total polymer weight. The polymers used may be polypropylene, polyamide, or polyester, for example, and may be in the form of a yarn or fiber, for example.

The present invention can incorporate non-woven fabrics that comprise or may include electrostatically charged polymers that increase the filtration efficiency of fibrous materials. These may be produced by corona charging, hydrocharging, induction and triboelectrification, etc. U.S. Pat. No. 6,197,709 discloses the use of electrostatically charged, non-woven composites in air filters. WO2019/222668 discloses the hydrocharging of filter media such as polyolefins (e.g., polypropylene) to form electrets thereof. Electroceutical fabrics such as those disclosed in U.S. patent application 2020/0006783 are also contemplated for use as filter materials in the present invention. U.S. Pat. No. 6,197,709, WO2019/222668, and U.S. patent application 2020/0006783 are incorporated herein by reference in the entirety.

These are only a few examples of the chemistry and physics of filter materials that enhance the anti-microbial and/or anti-viral layer or layers that may be used with the present filtering apparatus.

### Optimization

There are several key parameters that someone with ordinary skill in the art will understand related to the optimization of a filter of the present invention. Swirler parameters include swirler composition, length, radius, pitch, draft angle, and placement, that is, swirler distribution in a filter and the dimensional separation of swirlers from each other. Filter matrix parameters include composition, number of layers, thickness, volume, porosity/permeability, and specific functional characteristics (e.g., particle/droplet/aerosol capture capacity). The particular pore structure, geometry and how pores are integrated into a filter are also important considerations. Parameters can be scaled to best fit a particular application and the environment of use, which includes the expected airflow velocities and accelerations. For example, it is likely that filters used in masks will be scaled differently than filters designed for HVAC applications.

Optimization of the parameters of a filter for a particular application can be done empirically. According to Czypionka et al., for a mask to adequately protect one's self and others, there are three performance factors to consider: “filtration efficiency (its ability to block the full range of hazardous particles over different Levels of airflow), fit (to minimize leakage around the edges), and resistance (so the mask is not difficult to breathe through).” (Czypionka T, Greenhalgh T, Bassler D, Bryant MB. Masks and Face Coverings for the Lay Public: A Narrative Update. Ann Intern Med. 2021 April; 174(4):511-520. doi: 10.7326/M20-6625. Epub 2020 Dec. 29. PMID: 33370173; PMCID: PMC7774036.). For the present invention, fit becomes a lesser concern when filtration efficiency and resistance are optimized because the pressure differential across the filter is minimized due to its swirler/pore design. A lower pressure differential means that respiratory airflow into and out of the mask's periphery is also minimized. Therefore, for the present invention, optimization efforts are focused on an empirical process of adjusting parameters and evaluating filtration efficiency and resistance according to criteria known in the art and suggested by research institutes such as NIOHS and the NIH, and regulatory agencies such as OSHA and the FDA in the United States.

For masks, filtration resistance and efficiency test methods are specified by ASTM F1862 and ASTM F 1215, respectively. Fluid resistance is tested on a pass/fail basis at three velocities corresponding to the range of human blood pressure (80, 120, 160 mm Hg). Filtration efficiency can be measured by evaluating the penetration of a mask by 0.1 micron polystyrene latex spheres. Bacterial penetration tests can be performed using the method described by Greene and Vesley (Greene V W, Vesley D. Method for evaluating effectiveness of surgical masks. J Bacteriol. 1962 March; 83(3):663-7. doi: 10.1128/JB.83.3.663-667.1962. PMID: 13901536; PMCID: PMC279325) or specified in ASTM F2101 (“Standard Test Method for Evaluating the Bacterial Filtration Efficiency (BFE) of surgical masks using a Biological Aerosol of Staphylococcus aureus.”).

ANSI/ASHRAE Standard 52.2 or its equivalent is a testing specification for HVAC filters. This standard can be used to establish optimum parameters for the present invention when it is used in HVAC applications. One with ordinary skill in the art will know to use the latest versions of the above cited standards or their equivalents.

### Manufacturing Methods

The present invention can be produced in multiple ways. For example, vortex ports can be fabricated like grommets or eyelets that have helical blade members extending from their rings, which can be crimped, snap-fitted, or wedged together to hold the vortex ports in place in the outer material (e.g., plastic or fabric, etc.) of the mask or filter. These can be sharp on their distal ends so as to pierce through the thickness of a filter matrix thereby producing a bore with the swirler disposed through the filter.

Alternatively, the present invention can be fabricated by injection molding to produce an array of plastic vortex ports disposed on a first surface extending through holes made in a filter material and having snap fitted connectors coupling to a second surface wherein the filter material is sandwiched between the first and second surfaces. The vortex ports are disposed through the filter material.

Individual helical blades or arrays of helical blades can be fabricated by extrusion or twisting of metal, plastic, or other materials. For example, an extrusion process relevant to the present invention is similar or analogous to the way that spiral forms of pasta are extruded, for example, as disclosed in U.S. Pat. No. 10,117,448 which is incorporated herein by reference in the entirety.

Additive manufacturing, such as 3D printing, can also be used to fabricate the filter apparatus, including the vortex ports and swirlers. Micromachining and/or photolithography techniques can also be employed to produce dense and extremely small vortex port arrays for filters.

See, for example, U.S. Published Patent Application 2007/0295334, which discloses a method of making a face mask having multiple layers conferring anti-viral properties. All of the filter matrix materials may be used in conjunction with the present invention and the present filtering apparatus may be manufactured in view of the present specification. US Patent Publication 2014/0261430, which discloses a facial mask apparatus and a method of making it. Both of these US patent publications are incorporated herein by reference in the entirety. In particular, US Published Patent Application 2014/0261430 discloses a 3D printing method for making the mask.

The present filtration apparatus may also be used in HEPA (high efficiency particulate air) filter systems. HEPA systems are well known. For example, see U.S. Pat. No. 6,428,610, which is incorporated herein by reference herein in the entirety. This patent discloses a filter media for use in HEPA systems. It is explicitly contemplated that the present filtration apparatus may be used instead as a filter media in HEPA systems.

The present filtration media may also be used as an inline duct filter in HVAC systems. U.S. Published Patent Application 201710234575 is incorporated by reference herein in the entirety. For example, the present filtration apparatus may be used in place of air filter 21 in FIG. 1 of that patent application in an HVAC system.

The above embodiments are merely illustrative and are not intended to be limitative.

What is claimed is:

1. A filtration apparatus for improving quality of breathable air, comprising a plurality of vortex forming elements, each comprising:
a) a fixed swirler for imparting a centrifugal force on a moving air stream; and
b) a filter matrix for capturing particles contained within said moving air stream, wherein said vortex forming elements are disposed within said filter matrix.

2. The filtering apparatus of claim 1, wherein said plurality of vortex ports comprise a vortex port array.

3. The filtration apparatus of claim 1, wherein said fixed swirler in each vortex forming element is a helical blade.

4. The filtration apparatus of claim 1, wherein said fixed swirler in each vortex forming element is an impeller.

5. The filtration apparatus of claim 1, wherein said filter matrix comprises one or more layers.

6. The filtration apparatus of claim 5, wherein said one or more layers comprise at least one of anti-viral, anti-bacterial, absorbent or adsorbent layers.

7. The filtration apparatus of claim 1, which is a form of a face mask.

8. The filtration apparatus of claim 1, which is contained in a ventilator.

9. The filtration apparatus of claim 1, which is contained in a HEPA system.

10. The filtration apparatus of claim 1, which is contained in an HVAC system as a filter media.

11. The filtration apparatus of claim 1, which is designed to capture airborne particles as small as 0.3 microns.

12. A method of improving quality of breathable air, which comprises breathing air through the filtration apparatus of claim 1.

13. The method of claim 12, wherein said breathed air has a reduced pollen content

14. The method of claim 12, wherein said breathed air has a reduced viral aerosol content.

15. The method of claim 12, wherein said breathed air has a reduced dust particulate content.

16. The method of claim 15, wherein said particulate is coal dust.

17. The method of claim 12, wherein said filtration apparatus is a face mask.

18. The method of claim 12, wherein said filtration apparatus is contained in a ventilator system as a filter medium.

19. The method of claim 12, wherein said filtration apparatus is contained in an HVAC system as a filter medium.
